(19) United States
(12) Patent Application Publication
(10) Pub. No.: US 2019/0297035 A1
(43) Pub. Date: Sep. 26, 2019

(54) CHAT THREAD CORRECTION

(71) Applicant: International Business Machines Corporation, Armonk, NY (US)

(72) Inventors: Jeremy R. Fox, AUSTIN, TX (US); Jonathan Dunne, Dungarvan (IR); Kelley Anders, East New Market, MD (US); Liam S. Harpur, Dublin (IR)

(21) Appl. No.: 15/935,511

(22) Filed: Mar. 26, 2018

(51) Int. Cl. H04L 12/58; G06F 17/30

(52) U.S. Cl. CPC H04L 51/04; H04L 51/10; H04L 51/16; G06F 17/30528

(57) ABSTRACT

Computer-implemented system and method for transmitting a notification to a chat participant within a real-time chat conversation when the discussion reaches a predetermined emotive threshold, the thread contributors being alerted that emotive correction is required. Tone and sentiment analysis is used to determine emotional content of the thread and the level of conversation and linear discriminant analysis is used for topic analysis.

### FIELD

The present invention generally relates to computer systems, platforms or engines for enabling multi-person chat threads, and more particularly, a computer-implemented system and method for detecting an emotive level within an active chat thread or chat conversation, and when the discussion reaches an emotive threshold, inserting emotive corrections within the chat thread.

### BACKGROUND

In a chat message thread or a forum-based topic discussion, depending on the topic, (e.g. religion, politics, etc) discussion can get very heated as users discuss their own point of view. In the past, the discussion could end up in a “flame war”.

Like a real-time discussion that happens between people face to face, it would be useful to have a “voice of reason” who can help diffuse a situation before it gets to heated.

### SUMMARY

In one embodiment, there is provided a system, method and computer program product that allows an entity engaging in a real-time chat environment, e.g., a user, to infer or summarize emotive content of a real-time chat discussion or thread discussion and determine when a specific emotive content reaches a threshold.

The system, method, and computer program product further monitors and analyses the real-time chat conversation, infers when a discussion reaches an emotive threshold, and alerts the thread contributors that an emotive correction is required or inserts emotive corrections within the chat thread.

In one embodiment, there is provided a computer-implemented method of inserting emotive correction within a real-time chat thread. The method comprises: monitoring, using a processor, a real-time chat conversation using tone and sentiment analysis to determine an emotional content and level of the conversation and analyzing the conversation for topic analysis; determining, using the processor, and based on the tone and sentiment analysis and topic analysis, when the chat conversation of a participant has exceeded a predetermined emotional threshold level for a topic; and in response, using the processor for generating an alert message for display at a computing device of the participant that an emotive correction is required.

In a further aspect, there is provided a system for inserting emotive correction within a real-time chat thread. The system comprises: a memory storage system storing program instructions; a processor for running the stored instructions to configure the processor to: receive real-time chat thread conversation data from associated chat thread participants; monitor the received real-time chat thread conversation data using tone, sentiment and topic analysis to determine an emotional content and level of the real-time chat thread; determine based on the tone and sentiment analysis and topic analysis, when the chat conversation of a participant has exceeded a predetermined emotional threshold level for a topic; and in response, generate an alert message for display at a computing device of the participant that an emotive correction is required.

In a further aspect, there is provided a computer program product for performing operations. The computer program product includes a storage medium readable by a processing circuit and storing instructions run by the processing circuit for running a method. The method is the same as listed above.

### BRIEF DESCRIPTION OF THE DRAWINGS

Objects, features, and advantages of the present disclosure will become more clearly apparent when the following description is taken in conjunction with the accompanying drawings, in which:

FIG. 1 shows a flow chart of an exemplary method for practicing an aspect of the invention.

FIG. 2A shows an example real-time chat discussion displayed via a device interface.

FIG. 2B shows a scatter diagram and bar chart representing a topic analysis of a real-time chat discussion.

FIG. 2C shows an emotive analysis mapping that shows which portions of the chat discussion are associated with categorized emotions.

FIG. 3 shows a screenshot of an alert recommending that a user check their emotions based on something the user posted in the chat discussion.

FIG. 4 depicts an exemplary system architecture within which the methods for emotive correction within a chat thread are employed.

FIG. 5 shows a block diagram of an exemplary system for practicing an aspect of the invention.

FIG. 6 depicts a cloud computing environment according to an embodiment of the present invention.

FIG. 7 depicts abstraction model layers according to an embodiment of the present invention.

### DETAILED DESCRIPTION

A system, method and computer program product that monitors a real-time chat conversation involving two or more users, infers or summarizes in real-time the emotive content of the chat discussion or thread discussion in real time and determines when a specific emotive content reaches a threshold and generates an alert the thread contributors that an emotive correction is required. In one embodiment, the system may insert an emotive correction within the chat thread.

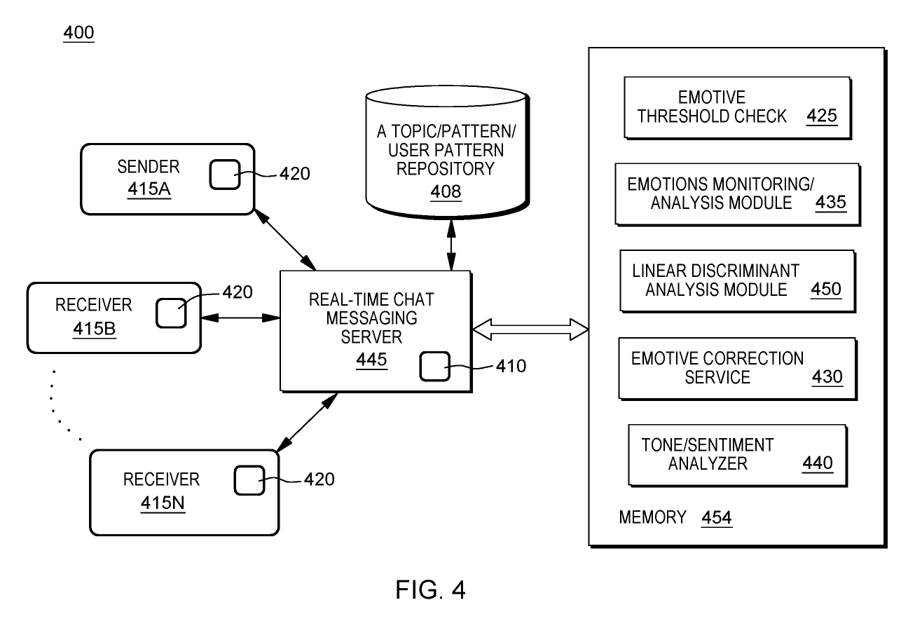

FIG. 4 conceptually depicts a communications system architecture 400 within which the present invention is employed. System architecture 400 includes computing devices employing a wide range of communication technologies that are configured to enable multiple users to conduct and participate in user communication “chat” sessions, e.g., by voice, email, text messaging, or the like. Communications may be commonly performed using various messaging services such as Instant Messaging (IM) for allowing a user to send and receive messages nearly instantaneously with other IM service users over a network or collection of networks, such as the Internet, and Short Message Service (SMS) service that enables users to exchange short text messages over a communication network. SMS is available on most mobile phones, some personal digital assistants and computers (typically via internet sites providing SMS services).

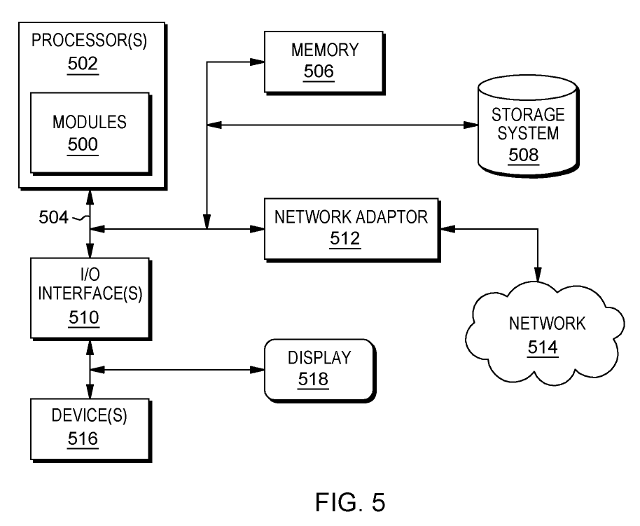

In particular, FIG. 4 shows an embodiment of a client-server-based IM system architecture 400 including a real-time chat instant messaging service center network element 410 for receiving messages from a sender device(s) over a communications network and re-transmitting the message to other receiver communication devices. The real-time chat instant messaging service center element is a computer server 445 that is further equipped with a memory 454 storing processing modules that include programmed instructions adapted to invoke operations for analyzing user chat messaging amongst the real-time chat users and performing emotive analysis detection and emotive correction insertion functions according to embodiments herein. In one embodiment, FIG. 5 depicts the real-time chat messaging service center server 445 as including one or more processors, a memory, e.g., for storing an operating system and program instructions, a network interface, a display device, an input device, and any other features common to a computing device. In some aspects, computing system 400 may, for example, be any computing device that is configurable to run a chat application or topic forum application as a web-site, for users via web- or cloud-based or mobile user computing devices, e.g., user devices 415A, 415B, . . . , 41N, etc. over a public or private wired and/or wireless communications system network (not shown). For example user devices 415A, 415B, . . . 415N may function as chat message receiver units, chat message sender units, etc. and equipped with a chat instant messaging client 420 adapted for chat messaging over a consumer instant messaging or enterprise instant messaging platform such as, but not limited to: IBM Sametime®, iMessage®, Skype®, Yahoo! ® Messenger, WeChat®, eBuddy®, or any other consumer-based or enterprise-based instant messaging system.

In one embodiment, the one or more programmed processing modules stored at the associated server memory 454 provide functionality and application program interfaces for providing the chat communications service and establishing real-time communicating (i.e., sending and receiving) of chat messages over a network amongst multiple users via their computing or mobile devices 415A, 415B, . . . 415N etc. Real-time chat instant messaging service center network element 410 further comprises rules for conducting real-time chat session among the multiple users.

As shown in FIG. 4, in one embodiment, real-time chat instant messaging service center network element 410 further interfaces with an emotions monitoring module 435, and when run by a processor at server 445, configures the system to invoke operations for real-time monitoring and detecting users' emotions or mood via their real-time chat text messaging or forum topic entries received in the system. The emotions monitoring module 435 may invoke operations employing an artificial intelligence tools such as a tone and sentiment analyzer 440. In one embodiment, instant messaging service center network element 410 may communicate and interface with International Business Machine's (IBM's) Watson® Tone Analyzer which may be employed to infer the user's tone, i.e., sentiment or emotion, e.g., based on that user's received digital communications, e.g., email, chat text messages, blogs, tweets, and forum posts. When running tone and sentiment analyzer 440, the system is able to determine an emotional content and level of the conversation.

In a non-limiting example, IBM's Watson® Tone Analyzer service uses linguistic analysis to detect emotional and language tones in written text. The module 440 employs the IBM Watson® Tone Analyzer service to analyze tone of the individual user messages or whole chat session and report the tone of the received input(s) as a representative score. The results of the tone may be used to detect a high emotional level when the score exceeds a threshold level.

The emotions monitoring module 435 may employ an artificial intelligence tool such as IBM Watson's® AlchemyAPI® and invoke machine learning operations, e.g., to perform natural language processing and specifically, semantic text analysis, including sentiment analysis.

In a non-limiting embodiment, emotions monitoring module 435 of the system 400 may analyze the text words or sentence(s) received during a live chat session and in particular, identifies nouns and adjectives that describe those nouns. A database containing a dictionary may be employed to provide information that is used by a scoring system that can generate a score based on the emotion analysis conducted. Based on this scoring, system changes may be made to the chat window showing live updates to the mood setting. Additionally, the chat session scoring may be recorded in a result storage database (RSD) and may be used for future statistical analysis.

As further shown in FIG. 4, in one embodiment, a linear discriminant analysis (LDA) module 450 is provided that invokes operations for real-time chat instant messaging service center network element 410 to find a linear combination of features that characterizes or separates two or more classes of objects or events. The resulting combination may be used as linear classifier for topic analyses and for classifying user emotions and user sentiment in logged text chat sessions.

In operation, during a chat message thread or a forum based topic discussion, depending on the topic, (e.g., religion, politics, etc.) the discussion can get very heated as users discuss their own point of view. In the past the discussion could end in a “flame war”.

The system architecture 400 of FIG. 4 performs monitoring a discussion within the real-time chat conversation using topic analysis module 440 and emotive analysis module 435, and employs functionality of an emotive threshold check module 425 to infer when a discussion reaches an emotive threshold. Once an emotive threshold has been reached or exceeded in a discussion, the system 400 may invoke an emotive message correction service module 430 to correct and re-publish the message and/or generate alerts to inform contributors that an emotive correction is required. The system is further configured to analyze the text of the chat discussion to determine if additional corrections are required. In one embodiment, if the text in a message utterance exceeds a pre-defined threshold, the message will require a correction, i.e., to reduce the level of negative emotion to conform to a threshold. The emotive analysis provides the type of correction which is required, and which the participant has the ability to insert such a correction.

While one embodiment of a system architecture employing real-time chat messaging server is shown in FIG. 4, it is understood that the system may be based on a micro service architecture having groups of micro services: e.g., the analysis/collection of services (e.g., employed using emotions monitoring/analysis module 435, tone/sentiment analysis module 440 and LDA module 450); and once emotive/tone/topic analysis is complete, the content is passed to the emotive threshold check module 425. If an emotive correction is required, the message content is augmented to reduce a particular characteristic of the message to fit below the threshold. Then the system may re-check the message content to ensure the emotive content is below the threshold. Finally, the message is re-published at the participants' respective client devices.

In one embodiment, it is possible that participants or users who insert emotive corrections may be tracked on a per space/channel/forum basis. Gamification methods may be employed to surface badges and rewards where necessary.

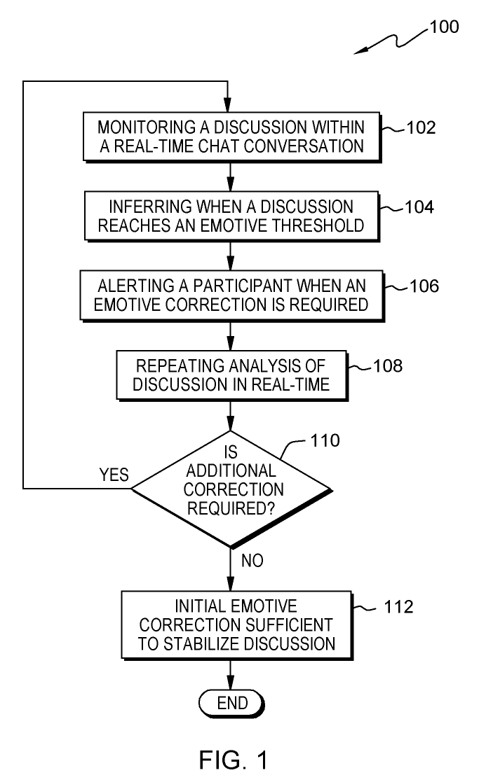

With reference now to FIG. 1, there is shown a flow chart of an exemplary method 100 for practicing an aspect of the invention.

At step 102, FIG. 1, the system 400 receives a data message communicated from a user device during the live chat session. In an embodiment, user messages may be received for posting as an entry in a web-based forum. In response, the real-time chat instant messaging service center network element 410 initiates the chat message emotive/tone analysis. For example, service center network element 410 invokes operations of emotions monitoring/analysis module 435 to monitor the discussion within the real-time chat messaging conversation or the forum entry post and generate an emotive score. Such emotive analysis may be performed by the AlchemyAPI®. In one embodiment, the real-time chat server 445 generates application programming interface (API) calls to forward received messages and forum posts to the Watson™ AlchemyAPI® to request that an emotive score be conducted. Alternatively, or in addition, network element 410 may further invoke operations of tone/sentiment analyzer module 440 employing IBM Watson's tone/emotive analysis functionality to generate an emotive score, e.g., a text score, based on five distinct emotions: Anger, Disgust, Fear, Joy and Sadness and three distinct tones: Analytical, Confident and Tentative. Alternately, or in addition, the system 400 may invoke LDA module 450 to employ linear discriminant analysis for topic modeling which is used to infer the topics discussed in chat discourse.

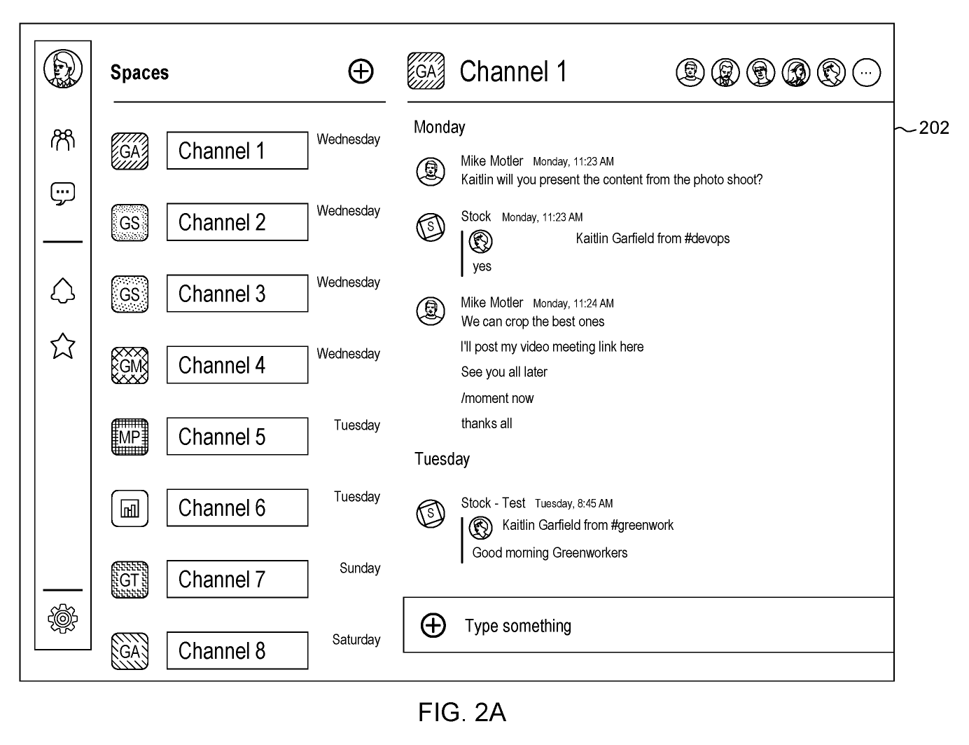

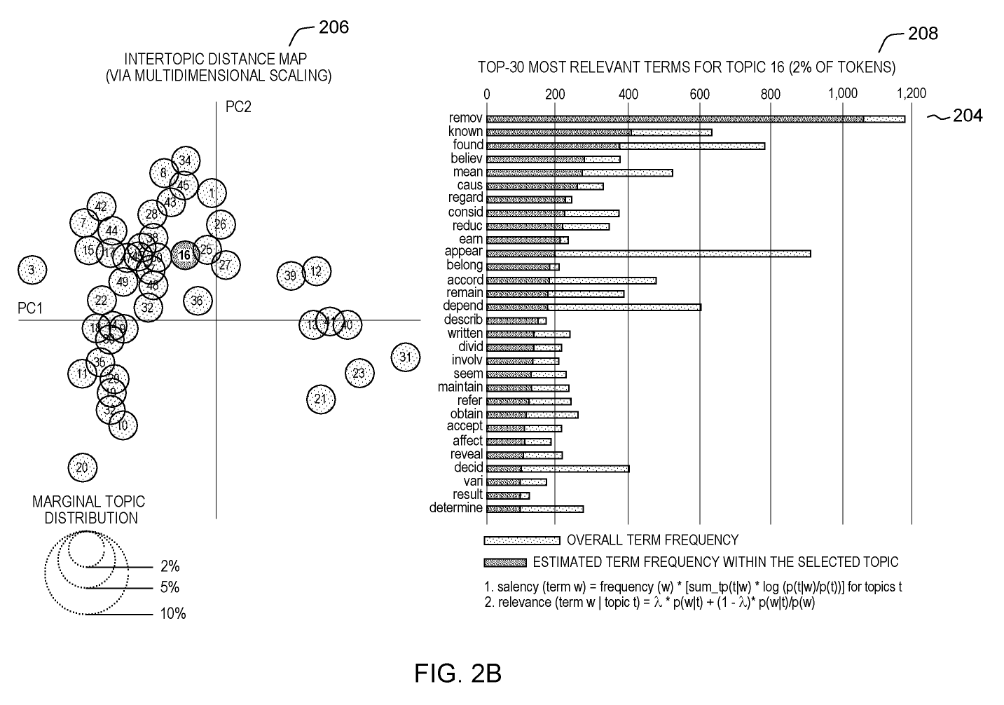

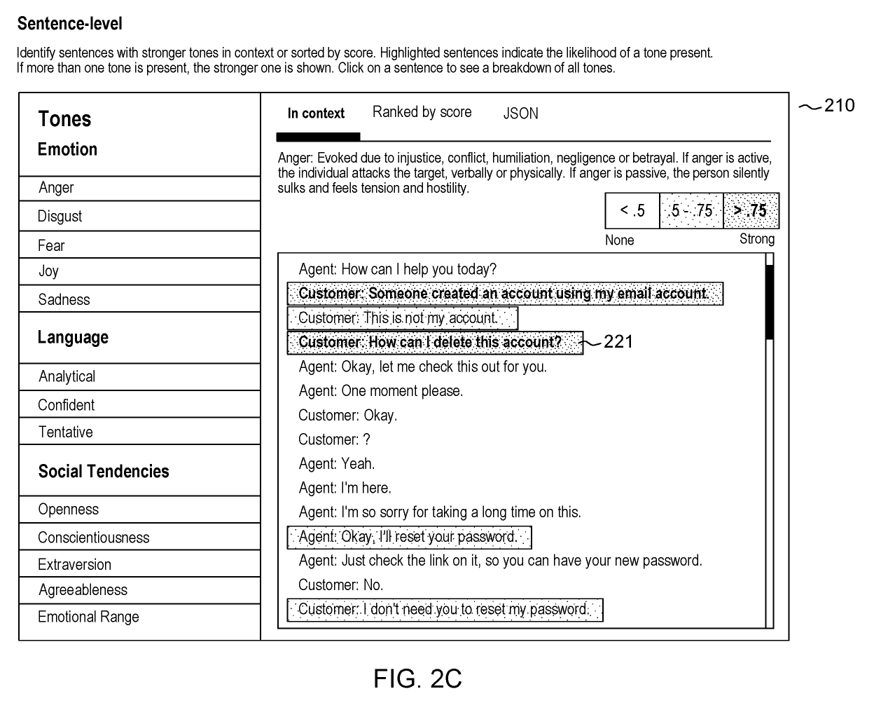

FIG. 2A shows an example screen display presentation on a user's computing device depicting a typical real-time chat discussion 202 among plural users. Server 445 of computing system 400 such as shown in FIG. 4 may provide such a communications service for multiple users to discuss topics or engage in chat messaging, e.g., pertaining to a topic.

FIG. 2B shows an example topic analysis 204 of an example chat discussion/thread, e.g., depicting results from conducting an LDA analysis. For example, calling the LDA analysis module 450 invokes operations for looking at a text corpus and inferring the most prominent terms used in discourse. In response, the computing system 400 of FIG. 4 may generate one or more of: a scatter diagram 206 and/or a bar chart 208 representing topic analysis of the chat. In FIG. 2B, the bar chart 208 depicts overall the most relevant terms entered by chat users for a particular topic of the subject chat or forum.

For example, terms included in a topic cluster can be enumerated and totaled to provide a term frequency. LDA also scores each term in a maximum likelihood estimation (MLE) score relevance. As shown in the intertopic distance map 206 of FIG. 2B, the larger the differential between MLE scores the greater the intertopic distance.

Table 1 below shows output from an LDA topic model output. As an example, the term “problem” has an MLE score of 0.135225 while the term “changes” has an MLE score of 0.070615. Thus, the intertopic distance is 0.06461.

TABLE 1

| Topic_Terms | Term_Score |
|---|---|
| problem | 0.135225 |
| trying | 0.118531 |
| full | 0.118531 |
| backport | 0.118531 |
| ati | 0.118531 |
| gave | 0.118531 |
| insane | 0.118531 |
| idea | 0.118531 |
| s | 0.018364 |
| oh | 0.001669 |
| oh | 0.116173 |
| btw | 0.116173 |
| think | 0.116173 |
| fix | 0.116173 |
| xv | 0.116173 |
| nvidia | 0.116173 |
| huh | 0.070615 |
| changes | 0.070615 |

FIG. 2C shows example results of an emotive analysis 210 conducted for an example chat discussion. In one embodiment, an emotions monitoring/analysis module 435 of the system 400 may analyze user entries of sentences in a current (real-time) chat session and generate scores that can be used to map a particular emotions category (e.g., anger, fear, joy, etc.) to a particular sentence(s) of the discussion. The example interface depicted in FIG. 2C, provides an example mapping showing which portions of the discussion are associated with categorized emotions. For example, sentence 221 entered by the user “customer” may have an associated tone such as “Anger” inferred on the basis of a computed score that is considered “strong”, i.e., greater than a predetermined threshold value, for example.

In particular, FIG. 2C is the interface depicting the passing of each message to an emotive scoring API which has determined that for the user referred to as “customer” the cumulative emotive angry score is above the 0.75 score. In other words, by summing the total emotive content within a predefined window, the summed emotive value is the score measured against the threshold (e.g., a value of 0.75).

While FIG. 2C depicts a scoring against a single emotion, e.g., anger, multiple emotions may be scored and evaluated in another scenario.

Referring back to FIG. 1, using the emotive threshold check module 425, it may be inferred at 104 when a discussion reaches an emotive threshold. In one embodiment, there are five core emotions detectable: Anger, Disgust, Fear, Joy and Sadness and each of these emotions can be measured on a scale from 0 to 1. For example, an example message posted to the real-time chat or discussion thread when analyzed by the emotive analysis monitoring system may result in the following emotive components:

### Joy 0.04, Anger 0.03, Disgust 0.01, Sadness 0.25 Fear 0.11

In one embodiment, a threshold may be set, by setting an upper limit on single or multiple emotions. For example, the real-time chat instant messaging service center network server may set an upper threshold on chat messages or posts as follows: Anger 0.75|Disgust 0.75|Sadness 0.75|Fear 0.75.

In the above threshold example, the five emotive values are checked against the emotive check threshold service 425. If one of these emotions is above a threshold the system flags what emotion is above the threshold, e.g., if they contain an emotive value of 0.75 or greater for any of the above four emotions. As the emotion “Joy” is a positive emotion, this does not have to be included. The threshold could initially be a hard coded value, however data mining may be used to infer the prior emotive content of discourse over a period of time and use that as an initial threshold. (i.e., a data driven approach).

Another example for setting predetermined thresholds to determine when chat discourse reaches a specific level of individual emotion is depicted in the following pseudo code:

if {
anger >= 0.3 OR joy >= 0.1
then
apply_emotive_correction
}

Thus for example, given input text:

Input text=“I had never spoken to her, except for a few casual words, and yet her name was like a spiteful summons to all my deadly foolish blood.”

The following action(s) may be taken at the emotive message correction service module 430 of computing system 400 of FIG. 4:

try
{
replace “spiteful summons”
with
“calling”
and
“spiteful summons to all my deadly foolish blood.”
with
“cry for survival.”
candidate text = recompute emotive analysis.
if {
anger >= 0.3 OR joy >= 0.1
then
apply_emotive_correction
else
output text = “I had never spoken to her, except for a few casual words,
and yet her name was like a calling, like a cry for survival.”
}

Thus, in this example, after a) monitoring emotive content in a message corpus, and b) inferring if the content exceeds a predefined emotive threshold, an emotive correction action may be provided which action may be taken by the emotive message correction service 430 at the computing system 400 of FIG. 4 to replace the input text with the following emotive corrected text:

output text=“I had never spoken to her, except for a few casual words, and yet her name was like a calling, like a cry for survival.”

Referring back to method 100 of FIG. 1, once detected that the emotive threshold is reached, at 106, the emotive message correction service module 430 of system 400 may be invoked to generate and communicate an alert to the chat thread contributors or chat participants that an emotive correction is required. Once the alert is communicated, the system or a user participant can insert a “voice of reason” utterance to lower the emotive level.

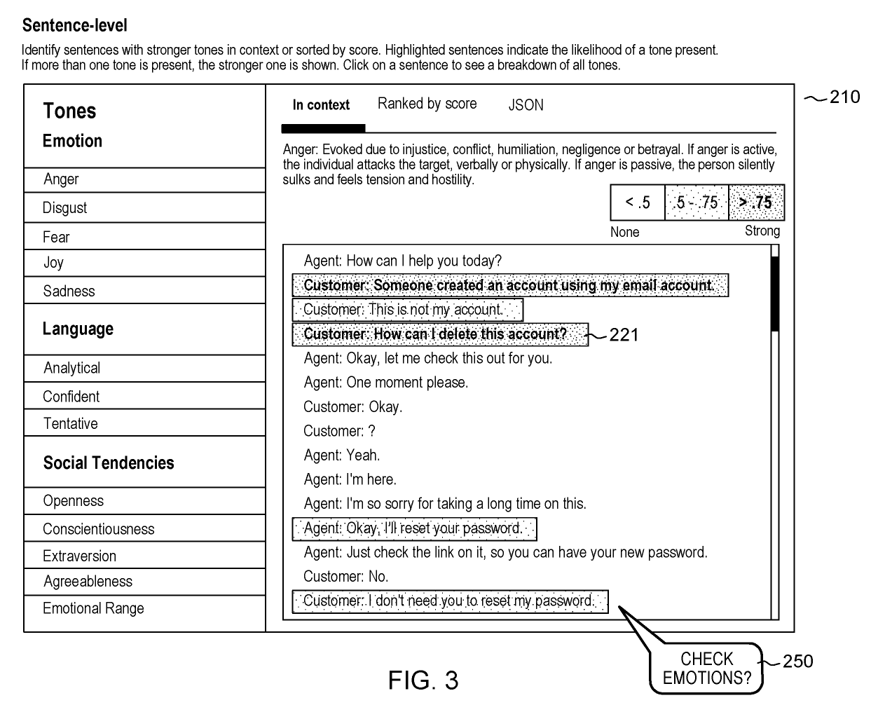

FIG. 3 shows a non-limiting example screenshot corresponding to the chat interface 210 of FIG. 2C showing the generating and displaying of an example alert 250. The example alert is generated for visual presentation via the chat session thread interface of a user device and in a non-limiting embodiment, is depicted as a talk bubble with the words “Check emotions?”. The alert is a recommendation for the user to check their emotions based on an item or items posted in the chat discussion.

Returning back to step 108, the method repeats analysis of the discussion in real-time to determine if additional correction is required 110 by repeating steps 102-108. Once it is determined that no additional emotive correction is required for the current chat, it is determined that the emotive correction was sufficient to stabilize the discussion 112, and the method ends.

In a further example illustrating emotive chat correction, each message received at system 400 has a unique author ID and device ID. Thus, the messaging chat server 445 will always know what user sent what content from what physical device. In a first example message post in JavaScript Object Motation (JSON) format shown below, the emotive content metrics are included:

{
“_id”: “56e0465d9932d8c08d4de99c”),
“content”: “@William - font is of different color in FF
(black) and Chrome (greyish)”,
“contentType”: “text/html”,
“authorId”: “72353640-8f4a-102b-8b12-99c200cfc5b7”,
“deviceId”: “965435e0-e60e-11e5-86d6-c91fc4b59bc6”,
“requestId”: “1457538658756”,
“chatRoomId”: “56e046219932d8c08d4de998”,
“hidden”: false,
“published”: “1457538653599),
“updated”: “1457538653599),
“publishedBy”: “72353640-8f4a-102b-8b12-99c200cfc5b7”,
“updatedBy”: “72353640-8f4a-102b-8b12-99c200cfc5b7”,
“version”: “0”
“Anger”: “0.03”
“Disgust”: “0.01”
“Fear”: “0.23”
“Joy”: “0.20”
“Sadness”: “0.05”
},

These five emotive values are checked against the emotive threshold service. If one of these emotions is above a threshold the system flags what emotion is above the threshold. For example, using the topic analysis initially conducted via the LDA module 450, the system may determine to replace message content words with synonyms and then recalculate the emotive scores. A second example message post shown below in JSON format shows the replacement of emotive correction message content and the corresponding different values for the emotive content metrics:

{
“_id”: “56e0465d9932d8c08d4de99c”),
“content”: “Hi William, our most prominent font looks
different in Firefox than in Chrome”,
“contentType”: “text/html”,
“authorId”: “72353640-8f4a-102b-8b12-99c200cfc5b7”,
“deviceId”: “965435e0-e60e-11e5-86d6-c91fc4b59bc6”,
“requestId”: “1457538658756”,
“chatRoomId”: “56e046219932d8c08d4de998”,
“hidden”: false,
“published”: “1457538653599),
“updated”: “1457538653599),
“publishedBy”: “72353640-8f4a-102b-8b12-99c200cfc5b7”,
“updatedBy”: “72353640-8f4a-102b-8b12-99c200cfc5b7”,
“version”: “0”
“Anger”: “0.06”
“Disgust”: “0.07”
“Fear”: “0.05”
“Joy”: “0.35”
“Sadness”: “0.12”
},

Thus, in this example, by replacing original chat message content:

“content”: “@William—font is of different color in FF (black) and Chrome (greyish)”,

with

“content”: “Hi William, our most prominent font looks different in Firefox than in Chrome”,

the “Fear” emotive content aspect has been reduced by 0.18.

In accordance with the embodiments herein, if a previously high emotive score is reduced enough to pass the threshold check a message republish is then conducted. The content of the change may be stored in a physical database for future use (i.e. for future machine learning).

Referring back to the system architecture 400 depicted in FIG. 4 there is described further aspects for practicing an aspect of the invention.

Participants 415A, 415B, . . . , 415N provide contributions to a thread conversation such as the thread conversation 202 shown in FIG. 2A. The thread conversation and the participants 415A, 415B, . . . , 415N associated with each contribution are provided to the thread analysis/emotions monitoring/analysis module 435 and/or LDA module 450 for analysis and combining of the discussion and sorting of emotions and topics associated with each of the users. In one embodiment, the output of the analysis and combining and sorting is provided to a topic/pattern/user pattern repository 408.

The data in the repository 408 is shared with the emotive corrective service module 445 which generates and provides notifications of necessary emotive corrections to the participants via their devices 415A, 415B, . . . , 415N in the discussion when the real-time chat conversation level has exceeded a predetermined emotional threshold for a topic. The appropriate participant receives an alert that a correction is necessary. The emotive corrective service module 445 for alerting the user may be alerted while still participating in the discussion, may provide additional functionality such as providing data for fact checking which could be a call to the repository that has stored the LDA to ensure that the context of the message matches known facts to assist the user to understand if they are overreacting. If the situation is escalating, in one embodiment, a “deep breathing” alert message may be generated and displayed to remind the user to do a task, and music 416, which can cue a known piece of soothing music for the user, may be automatically streamed for playback at the message thread as an emotive insertion when the threshold is reached. Although not shown, a pattern analysis and application engine may receive data from the topic/pattern/user pattern repository 408 for analyzing the discussion. Each of the data recipients 415A, 415B, . . . , 415N and pattern analysis and application engine supplies data used to form an emotive correction for the discussions and messages to the chat participants. In response to the alert message, a participant corrects the discussion and the corrected discussion may be provided to the pattern analysis and application engine.

FIG. 5 illustrates an example system in accordance with the present invention. By way of overview and example only, some embodiments may orchestrate insertion of emotive correction within a chat thread. The system depicted is only one example of a suitable system and is not intended to suggest any limitation as to the scope of use or functionality of embodiments of the invention. In contrast, the present invention may be operational with numerous other general purpose or special purpose computing systems, environments and/or configurations. A few examples of well-known computing systems, environments, and/or configurations that may be suitable for use with the system shown in FIG. 5 include (but are not limited to), personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The system of FIG. 5 may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

As depicted, the components of the system of FIG. 5 may include (but are not limited to), one or more processors or processing units 502, a system memory 506, and a bus 504 that operably couples various system components including system memory 506 to processor 502. The processor 502 may execute one or more modules 500 that performs methods in accordance with the present invention. The module 500 may be programmed into the integrated circuits of the processor 502, or loaded from memory 506, storage system 508, or network 514 or combinations thereof.

Bus 504 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 506 can include computer system readable media in the form of volatile memory, such as random access memory (RAM) and/or cache memory or others. Computer system may further include other removable/non-removable, volatile/non-volatile computer system storage media. By way of example only, storage system 508 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 504 by one or more data media interfaces.

Computer system may also communicate (via Input/Output (I/O) interfaces 510) with one or more external devices 516, such as a keyboard, a pointing device, a display 518, and/or one or more other devices that enable a user to interact/interface with the computer system; and/or any devices (e.g., network card, modem, network adaptor 512, etc.) that enable computer system to communicate with one or more other computing systems/devices. Such communication can occur via Input/Output (I/O) interfaces 510 and/or network adaptor 512.

By way of further example, the computer system of FIG. 5 can communicate with one or more networks 514, such as a local area network (LAN), a general wide area network (WAN), and/or a public network (e.g., the Internet) via network adapter 512. As depicted, network adapter 512 can also facilitate communication with other components of the computer system of FIG. 5 via bus 5604. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s).

In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In one embodiment, a computing system, environment, and/or configuration that may be suitable for use with the system shown in FIG. 4 includes a cloud computing environment.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. The characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows: Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows: Private cloud: the cloud infrastructure is operated solely for an organization. It may be managed by the organization or a third party and may exist on-premises or off-premises. Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

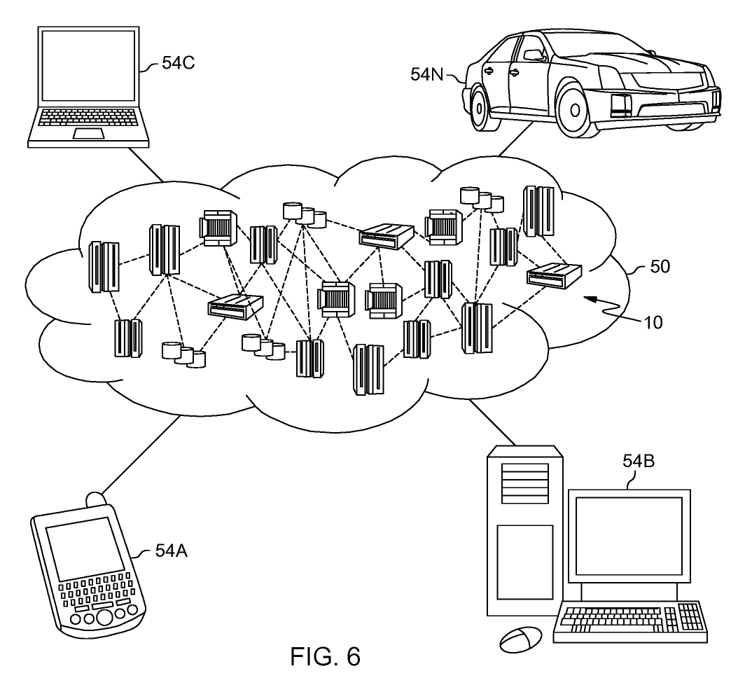

Referring now to FIG. 6, illustrative cloud computing environment 50 is depicted. As shown, cloud computing environment 50 includes one or more cloud computing nodes 400 with which local computing devices used by cloud consumers, such as, for example, personal digital assistant (PDA) or cellular telephone 54A, desktop computer 54B, laptop computer 54C, and/or automobile computer system 54N may communicate. Nodes 400 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 400 and cloud computing environment 50 can communicate with any type of computerized device over any type of network and/or network addressable connection (e.g., using a web browser).

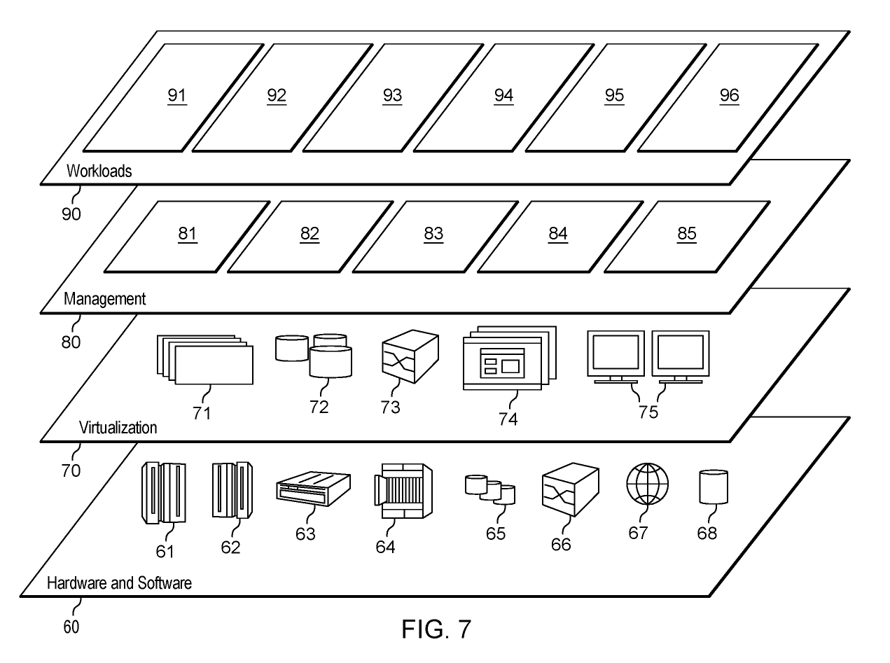

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA. Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and real-time chat emotion analysis and emotive correction insertion processing 96. The real-time chat emotion analysis is able to infer a summary emotive content of a chat discussion or thread discussion in real time, determine when a specific emotive content reached a threshold, what type of emotive correction is required, and determine which person has the ability to insert such a correction.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method of inserting emotive correction within a real-time chat thread comprising:
monitoring, using a processor, a real-time chat conversation using tone and sentiment analysis to determine an emotional content and level of the conversation and analyzing the conversation for topic analysis;
determining, using the processor, and based on the tone and sentiment analysis and topic analysis, when the chat conversation of a participant has exceeded a predetermined emotional threshold level for a topic; and in response,
using the processor for generating an alert message for display at a computing device of the participant that an emotive correction is required.

2. The computer-method of claim 1, wherein the processor is configured to: repeat the monitoring and the emotional threshold level determining to determine whether further alerting is necessary.

3. The computer-method of claim 1, further comprising:
combining, by the processor, the monitoring by associating thread analysis, emotion and topic, with respective participants.

4. The computer-method of claim 1, further comprising: using the processor to perform the topic analysis using linear discriminant analysis.

5. The method of claim 1, further comprising:
generating, by the processor, for a chat message received from a user, an emotive content score;
comparing, by the processor, the emotive content score against the predetermined emotional threshold level; and
upon detecting the emotive content score of the chat conversation of a participant has exceeded the predetermined emotional threshold level, inserting the alert message in the real-time chat thread of that participant.

6. The method of claim 1, further comprising:
generating, by the processor, for a chat message received from a user, an emotive content score;
comparing, by the processor, the emotive content score against the predetermined emotional threshold level; and
upon detecting the emotive content score of the chat conversation of a participant has exceeded a predetermined emotional threshold level, generating, by the processor, further message content to replace content of the received chat message, the generated further message reducing the emotive content score of the received chat message to a value below the predetermined emotional threshold level.

7. The system of claim 1, wherein the processor is further configured to:
receive, from a memory storage system, stored emotive correction data; and
insert emotive corrected real-time thread conversation data into the real-time chat thread.

8. A system for inserting emotive correction within a real-time chat thread comprising:
a memory storage system storing program instructions;
a processor for running the stored instructions to configure the processor to:
receive real-time chat thread conversation data from associated chat thread participants;
monitor the received real-time chat thread conversation data using tone, sentiment and topic analysis to determine an emotional content and level of the real-time chat thread;
determine based on the tone and sentiment analysis and topic analysis, when the chat conversation of a participant has exceeded a predetermined emotional threshold level for a topic; and in response,
generate an alert message for display at a computing device of the participant that an emotive correction is required.

9. The system of claim 8, wherein the processor is further configured to:
receive, from the memory storage system, stored emotive correction data; and
insert emotive corrected real-time thread conversation data into the real-time chat thread.

10. The system of claim 8, wherein the generated message comprises one or more of: fact check data, deep breath data, or music data.

11. The system of claim 8, wherein the processor is further configured to:
generate for a chat message received from a user, an emotive content score; and
compare the emotive content score against the predetermined emotional threshold level, and
upon detecting the emotive content score of the chat conversation of a participant has exceeded the predetermined emotional threshold level, insert the alert message in the real-time chat thread of that participant.

12. The system of claim 8, wherein the processor is further configured to:
generate, for a chat message received from a user, an emotive content score;
compare the emotive content score against the predetermined emotional threshold level;
upon detecting the emotive content score of the chat conversation of a participant has exceeded a predetermined emotional threshold level; and
generate further message content to replace content of the received chat message, the generated further message reducing the emotive content score of the received chat message to a value below the predetermined emotional threshold level.

13. A computer program product for inserting emotive correction within a real-time chat thread, the computer program product comprising a non-transitory computer readable storage medium having program instructions embodied therewith, the program instructions executable by a computer to perform a method comprising:
monitoring a real-time chat conversation using tone and sentiment analysis to determine an emotional content and level of the conversation and analyzing the conversation for topic analysis;
determining, based on the tone and sentiment analysis and topic analysis, when the chat conversation of a participant has exceeded a predetermined emotional threshold level for a topic; and in response,
generating an alert message for display at a computing device of the participant that an emotive correction is required.

14. The computer program product of claim 13, wherein the program instructions further configure the computer to: repeat the monitoring and the emotional threshold level determining to determine whether further alerting is necessary.

15. The computer program product of claim 13, wherein the program instructions further configure the computer to:
combine the monitoring by associating thread analysis, emotion and topic, with respective participants.

16. The computer program product of claim 13, wherein the program instructions further configure the computer to perform the topic analysis using linear discriminant analysis.

17. The computer program product of claim 13, wherein the program instructions further configure the computer for:
generating for a chat message received from a user, an emotive content score;
comparing the emotive content score against the predetermined emotional threshold level, and
upon detecting the emotive content score of the chat conversation of a participant has exceeded the predetermined emotional threshold level, inserting the alert message in the real-time chat thread of that participant.

18. The computer program product of claim 13, wherein the program instructions further configure the computer for:
generating for a chat message received from a user an emotive content score;
comparing the emotive content score against the predetermined emotional threshold level; and
upon detecting the emotive content score of the chat conversation of a participant has exceeded a predetermined emotional threshold level, generating further message content to replace content of the received chat message, the generated further message reducing the emotive content score of the received chat message to a value below the predetermined emotional threshold level.

19. The computer program product of claim 13, wherein the program instructions further configure the computer to:
receive, from a memory storage system, stored emotive correction data; and
insert emotive corrected real-time thread conversation data into the real-time chat thread.
